(19) United States
(12) Patent Application Publication
(10) Pub. No.: US 2016/0147400 A1
(43) Pub. Date: May 26, 2016

(54) TAB BASED BROWSER CONTENT SHARING

(71) Applicant: Microsoft Technology Licensing, LLC, Redmond, WA (US)

(72) Inventor: Michael J. Patten, Sammamish, WA (US)

(21) Appl. No.: 14/554,401

(22) Filed: Nov. 26, 2014

(51) Int. Cl. G06F 3/0484; H04L 29/08; G06F 3/0483

(52) U.S. Cl. CPC G06F 3/0484; G06F 3/0483; H04L 67/02; H04L 67/10

(57) ABSTRACT

Methods, systems, apparatuses, and computer program products are provided for sharing browser content. A first browser tab is invoked within a web browser operating in a first computing device. The first browser tab displays first content. A selection of a first contact with which to share the first browser tab is received at a user interface of the first computing device. A share notification is transmitted to the first contact. An acceptance indication is received from a second computing device on behalf of the first contact. Display of the first browser tab at the second computing device is enabled. The first contact is enabled to interact with the first content of the first browser tab at the second computing device. Interactions by the first contact with the first content at the second computing device are displayed in the first browser tab at the first computing device. Display of a screen of the first computing device at the second computing device is confined to the first browser tab.

### BACKGROUND

A browser is an application that is used for traversing, retrieving, and presenting information resources, such as resources available on the Internet. People today use browsers to complete common tasks, and sometimes may collaborate to complete a task using a browser. For example, a married couple may be planning a family vacation, and may need to book airline tickets. The wife may be at work using a web browser to look up flights on a travel website. The husband may be located at home, and may or may not have access to a web browser himself. The couple may want to book the tickets together to ensure that the dates and seats that both of them prefer are selected. To accomplish this, the wife may share screenshots of her browser with her husband. Or they can try to browse the website simultaneously, but even if both of them navigate to the same website, they cannot be sure that they are looking at the same set of data.

Multiple solutions are available that allow sharing of a desktop screen or desktop window to other devices. Examples of such programs include desktop sharing applications, such as Citrix® GoToMeeting®, and web conferencing applications, such as Microsoft® Lync™, and Cisco® Webex®. These applications allow a person to share/project their entire desktop screen.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Methods, systems, apparatuses, and computer program products are provided for sharing browser content. A browser tab is invoked within a web browser operating in a local/host computing device. The browser tab displays content. A selection of one or more contacts with which to share the browser tab is received at a user interface of the host computing device. A share notification is transmitted to the contact(s). An acceptance indication is received from one or more remote/client computing devices on behalf of the contact(s). Display of the browser tab is enabled at the remote computing devices of the accepting contacts. Each contact is enabled to interact with the content of the browser tab at the respective remote computing device. Interactions by the contact(s) with the content at the remote computing device(s) are displayed in the browser tab at the host computing device. Display of a screen of the host computing device at the remote computing device(s) is confined to the browser tab.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate embodiments of the present application and, together with the description, further serve to explain the principles of the embodiments and to enable a person skilled in the pertinent art to make and use the embodiments.

FIG. 1 shows a block diagram of communication system in which a computing device shares a browser tab for display and interaction at one or more other computing devices, according to an example embodiment.

FIG. 2 shows a flowchart providing a process for sharing browser tabs with one or more contacts, according to an example embodiment.

FIG. 3 shows a block diagram of a computing device configured to share a browser tab for display and interaction at one or more other computing devices, according to an example embodiment.

FIG. 4 shows a display screen that displays a web browser having multiple open browser tabs, where one of the browser tabs is active and is being selected for sharing, according to an example embodiment.

FIG. 5 shows the display screen of FIG. 4, where an interface is displayed for selecting a contact with which to share the active browser tab, according to an example embodiment.

FIG. 6 shows a flowchart providing a process for selecting a communication provider for sharing a browser tab, according to an example embodiment.

FIG. 7 shows the display screen of FIG. 4, where an interface is displayed for selecting a communication provider for sharing the active browser tab, according to an example embodiment.

FIG. 8 shows a display screen at a remote computing device, where a request to share a browser tab is received, according to an example embodiment.

FIG. 9 shows a display screen at a remote computing device, where the active browser tab of FIG. 4 is shared, according to an example embodiment.

FIG. 10 shows a flowchart providing a process for enabling display of a browser tab at a remote computing device, according to an example embodiment.

FIG. 11 shows the display screen of FIG. 4, where multiple browser tabs are being shared with contacts at remote computing devices, according to an example embodiment.

FIG. 12 shows a block diagram of an exemplary user device in which embodiments may be implemented.

FIG. 13 shows a block diagram of an example computing device that may be used to implement embodiments.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

Introduction

The present specification and accompanying drawings disclose one or more embodiments that incorporate the features of the present invention. The scope of the present invention is not limited to the disclosed embodiments. The disclosed embodiments merely exemplify the present invention, and modified versions of the disclosed embodiments are also encompassed by the present invention. Embodiments of the present invention are defined by the claims appended hereto.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Numerous exemplary embodiments are described as follows. It is noted that any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner

II. Example Embodiments for Sharing Browser Content with Contacts

A browser is an application that is used for traversing, retrieving, and presenting information resources, such as resources available on the Internet. People today use browsers to complete common tasks, and sometimes may collaborate to complete a task using a browser. However, even if collaborators located at different locations navigate to the same website, they cannot be sure that they are looking at the same set of data.

Multiple solutions are available that allow sharing of a desktop screen or desktop window to other devices. When a browser window is shared with another computing device in this manner, all of the open tabs of the browser window are shared, as well as the rest of the display screen of the sharing computing device, which may not be desirable. The user of the computing device that is sharing content may only want to share a single tab, while keeping the other browser tabs private/unshared.

Furthermore, the configuring of remote sharing of content can be tedious and involve multiple steps to initiate the sharing. For example, a local user may need to start a conversation with a remote user that they want to share content with, may need to choose the desktop or window for sharing, and then may need to pass control back and forth with the remote user to allow them to interact with the local user's screen.

Embodiments enable browsing sessions to be immediately and efficiently shared with friends, family, and/or anyone else, between any types of computing devices, including devices running Microsoft Windows®, Apple iOS®, or Google Android™ operating systems. Unlike other sharing solutions, a user can simply initiate “Share”, and select one or more contacts to share with, and the current browsing session tab is automatically shared. Remote users can interact with the shared browser tab, such as by panning, zooming, and adding annotations. Unlike other solutions, the local user can choose which tab(s) to share without sharing other screen information, and the local user is in control (e.g., can end the share session, can disable interactions by the remote user(s), etc.).

For instance, in one example provided for purposes of illustration, within a Microsoft® Internet Explorer® browser, a local user (on a local computing device, or host machine) may select a Skype® button. A Skype panel may appear that shows a list of available contacts who are online. The local user chooses which contact(s) to start to share the current browser tab with. A current active browser tab on the local computing device is automatically shared with the selected contacts. The contacts receive notification via Skype that the local user wants to initiate a multi-user browser session. Each of the contacts has the option to accept the invite, and each contact that accepts is provided with a display of the shared tab content. All participating users (the local user and accepting contact(s)) can interact with the current tab window. For example, the remote user(s) can pan the page, zoom, select links etc. This is accomplished by sending “control commands” from the computing device(s) of the remote user(s) to the hosting local computing device. This includes inputs from any sort of user interfaces, including keyboard, mouse, touch, Kinect (e.g., gestures), voice, etc.

The local user (i.e., the host user) can configure which remote users can interact with the shared tab by sending commands For example, remote users A and B may be allowed to interact, but remote user C may be disallowed from interacting. The local user (presenter) can stop the sharing at any time. The local computing device can share multiple tabs at the same time. Each tab can be shared with a specific set of one or more remote users. For example, tab 1 may be shared with remote users A and B, and tab 2 may be shared with remote users A and C.

On screen affordances (e.g., controls) indicate which tabs are currently being shared, and may indicate who the tabs are being shared with. The remote users viewing a shared browser tab may have a supported remote desktop and/or screen sharing application installed on the remote computing device(s).

Accordingly, in embodiments, one or more browser tabs are enabled to be shared with one or more people. All of the users sharing a particular browser tab can interact with the shared tab at the same time, without the need to pass control back and forth. Sharing is enabled directly within a browser, and few setup steps are involved. The browser is enabled to be shared with people across the same or different operating systems and device types.

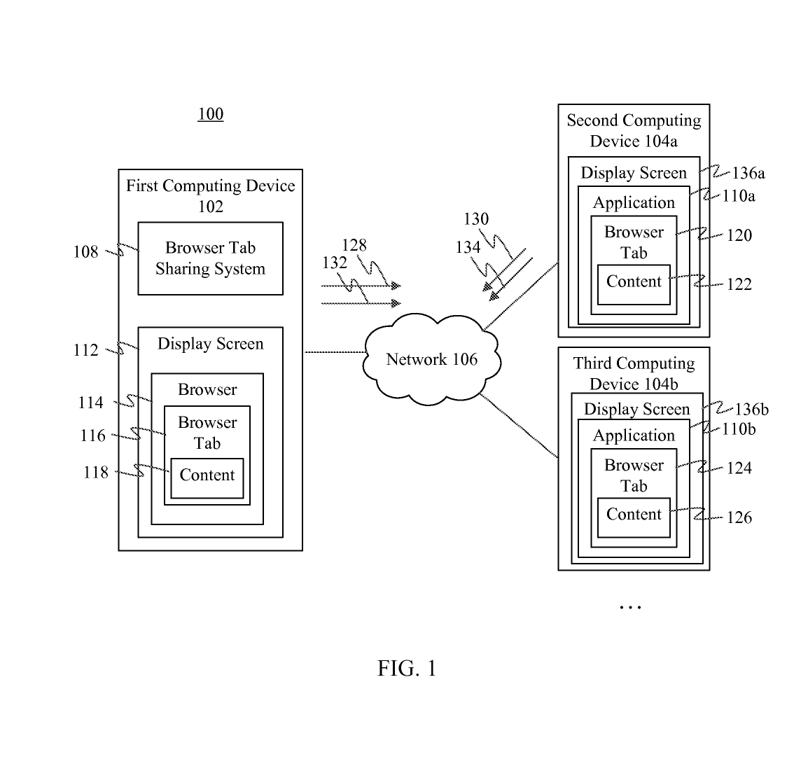

Embodiments may be implemented in various environments. For instance, FIG. 1 shows a block diagram of communication system 100 in which a computing device shares one or more browser tabs for display and interaction at one or more other computing devices, according to an example embodiment. As shown in FIG. 1, communication system 100 includes a first computing device 102, a second computing device 104a, and a third computing device 104b. A network 106 communicatively couples computing devices 102, 104a, and 104b. Computing device 102 includes browser tab sharing system 108 and a display screen 112. Computing device 104a includes an application 110a and a display screen 136a, and computing device 104b includes an application 110b and a display screen 136b. System 100 is further described as follows.

Computing devices 102, 104a, and 104b may each be any type of stationary or mobile computing device, including a mobile computer or mobile computing device (e.g., a Microsoft® Surface® device, a personal digital assistant (PDA), a laptop computer, a notebook computer, a tablet computer such as an Apple iPad™, a netbook, etc.), a mobile phone (e.g., a cell phone, a smart phone such as a Microsoft Windows® phone, an Apple iPhone, a phone implementing the Google® Android™ operating system, a Palm® device, a Blackberry® device, etc.), a wearable computing device (e.g., a smart watch, a head-mounted device including smart glasses such as Google® Glass™, etc.), or other type of mobile device (e.g., an automobile), or a stationary computing device such as a desktop computer or PC (personal computer). Still further, computing devices 102, 104a, and 104b may each be a portable media player, a stationary or handheld gaming console, a personal navigation assistant, a camera, or other type of stationary or mobile device. First computing device 102 is considered a host or local computing device, and second and third computing devices 104a and 104b are considered client or remote computing devices in FIG. 1. Although a pair of client or remote computing devices are shown in FIG. 1, in other embodiments, other numbers of client or remote computing devices may be present in system 100, including one or other numbers in the single digits, numbers in the tens, hundreds, thousands, or even greater numbers of client or remote computing devices.

Each of computing devices 102, 104a, and 104b may include at least one network interface that enables communications over network 106. Such a network interface may be one or more of any type of network interface (e.g., network interface card (NIC)), wired or wireless, such as an as IEEE 802.11 wireless LAN (WLAN) wireless interface, a Worldwide Interoperability for Microwave Access (Wi-MAX) interface, an Ethernet interface, a Universal Serial Bus (USB) interface, a cellular network interface, a Bluetooth™ interface, a near field communication (NFC) interface, etc. Further examples of network interfaces are described elsewhere herein. Examples of network 106 include a local area network (LAN), a wide area network (WAN), a personal area network (PAN), and/or a combination of communication networks, such as the Internet.

Browser tab sharing system 108 is configured to enable a user at computing device 102 to share one or more browser tabs displayed by a display screen 112 of computing device 102 with one or more other users. For example, a browser tab 116 operating in a browser 114 and displaying content 118, may be shared with one or more other users. The host user may select a share option provided by browser tab sharing system 108 in association with browser tab 116 to cause a sharing of browser tab 116 to be initiated. For instance, the user may interact with a control (e.g., touch, click on, speak a predetermined word or phrase, make a predetermined gesture, etc.) to initiate the sharing, or may cause the sharing to be initiated in another way. The user may select a contact (an identified user) to share with, and may optionally select a communication provider (e.g., a web conferencing tool, a desktop sharing tool, etc.) to enable the sharing to occur via communications over network 106. A sharing request 128 may be transmitted by browser tab sharing system 108 to a computing device of a selected contact over network 106, in this example being second computing device 104a. The contact may interact with an application 110a at computing device 104a to accept or decline sharing request 128. If the contact accepts sharing request 128, second computing device 104a may transmit a share acceptance 130 over network 106 to browser tab sharing system 108 at computing device 102.

As a result, browser tab sharing system 108 may transmit browser tab display information 132 to computing device 104a over network 106, which includes information that enables application 110a to display browser tab 116 in display screen 136a as browser tab 120. Display information 132 includes interactions with browser tab 116 by the user at computing device 102. In this manner, the interactions by the user with browser tab 116 at computing device 102 may be displayed to the contact at computing device 104a in browser tab 120. The contact may interact with browser tab 120 displayed by application 110a at computing device 104a, and application 110a may transmit interaction information 134 describing these interactions over network 106 to browser tab sharing system 108 at computing device 102. In this manner, the interactions by the contact with browser tab 120 at computing device 104a may be displayed to the user at computing device 102 in browser tab 116.

In a similar manner, browser tab sharing system 108 enables the user at computing device 102 to share browser tab 116 with further contacts at further computing devices in system 100, such as third computing device 104b. The sharing of the same browser tab with multiple contacts may be simultaneous. Furthermore, browser tab sharing system 108 enables the user at computing device 102 to share further browser tabs of browser 114 with contacts at any number of computing devices in system 100, including sharing the further browser tabs with the same contacts or different contacts. The sharing of multiple browser tabs of a same browser and/or of different browsers may be simultaneous.

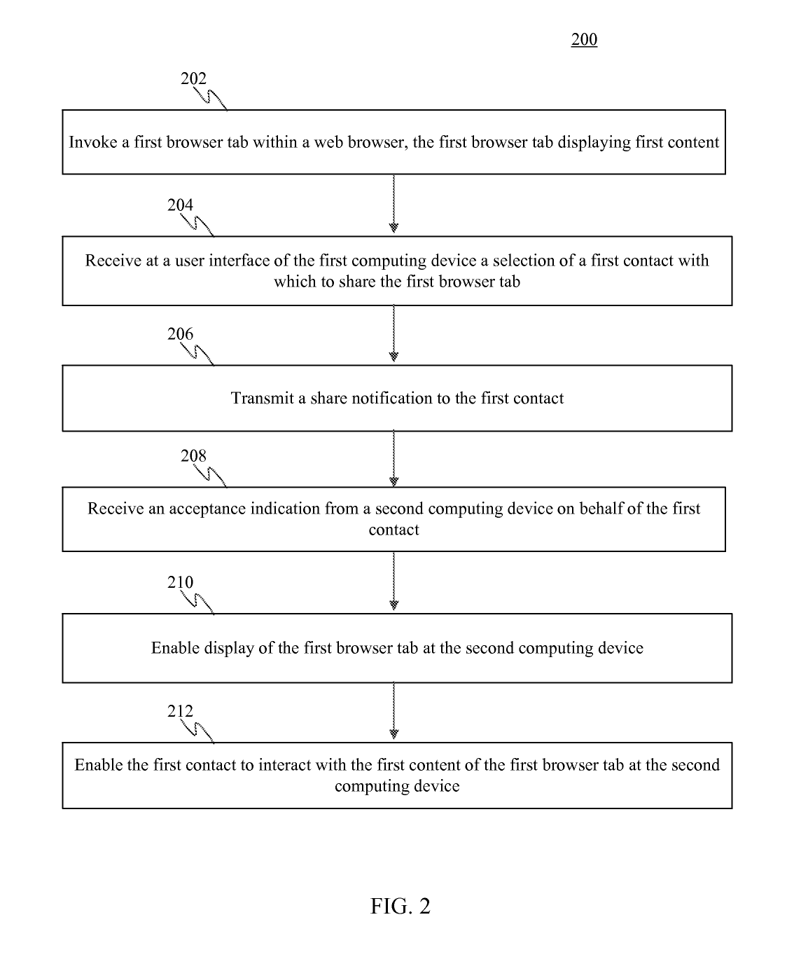

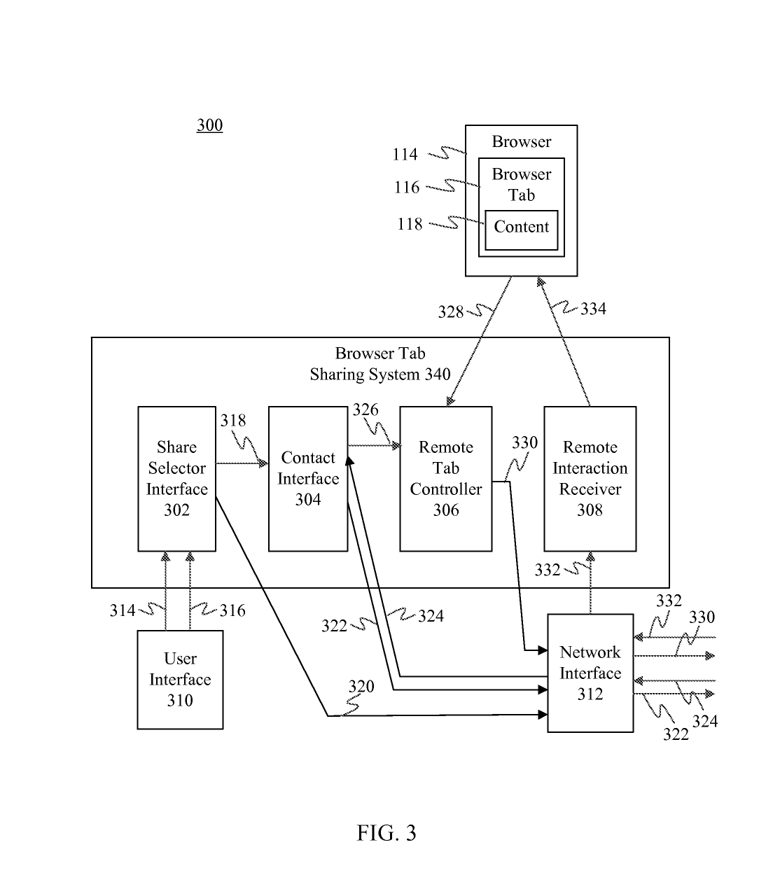

In embodiments, browser tab sharing system 108 of FIG. 1 may be configured in various ways, and may operate in various ways, to enable browser tab sharing. For instance, FIG. 2 shows a flowchart 200 providing a process for sharing browser tabs with one or more contacts, according to an example embodiment. Browser tab sharing system 108 may operate according to flowchart 200 in embodiments. For illustrative purposes, flowchart 200 is described below with respect to FIG. 3. FIG. 3 shows a block diagram of a computing device 300 configured to share a browser tab for display and interaction at one or more other computing devices, according to an example embodiment. Computing device 300 is an example of computing device 102 and browser tab sharing system 340 is an example of browser tab sharing system 108 of FIG. 1. As shown in FIG. 3, computing device 300 includes browser 114, a user interface 310, a network interface 312, and browser tab sharing system 340. Browser 114 displays browser tab 116, which includes content 118 (e.g., text, images, videos, audio, hyperlinks, other objects, etc.). Furthermore, browser tab sharing system 340 includes a share selector interface 302, a contact interface 304, a remote tab controller 306, and a remote interaction receiver 308.

Further structural and operational embodiments will be apparent to persons skilled in the relevant art(s) based on the following description of FIGS. 2 and 3. For example, although browser tab sharing system 340 is shown separate from browser 114 in FIG. 3, in another embodiment, browser tab sharing system 340 may be integrated in browser 114. When integrated in browser 114, browser tab sharing system 340 may be a plug in or add-in, or may be directly integrated in the program code of the web browser. Examples of web browsers applicable to browser 114 include Internet Explorer®, developed by Microsoft Corp. of Redmond, Wash., Mozilla Firefox®, developed by Mozilla Corp. of Mountain View, Calif., Safari®, developed by Apple Inc. of Cupertino, Calif., and Google® Chrome of Mountain View, Calif.

Flowchart 200 of FIG. 2 begins with step 202. In step 202, a first browser tab is invoked within a web browser, the first browser tab displaying first content. In an embodiment, browser 114 in FIG. 3 may invoke browser tab 116. For instance, a user may interact with browser 114 to cause browser tab 116 to be invoked, such as by using a pull down menu, by interacting with a browser control (e.g., a new tab control) by mouse click, touch, voice, gesture, etc., or may cause a browser tab to be invoked in another manner. Browser tab 116 may be one of multiple browser tabs of browser 114, or may be the only open browser tab of browser 114.

A browser tab is an entity that operates like a browser window to display and allow interaction with content. A browser window (e.g., the displayed instance of browser 114) may include one or multiple browser tabs, where each browser tab may be used to display a respective web page. The browser window may display the browser tabs in a tiled fashion, such that the outermost browser tab is active and is displayed, while the other browser tabs are underneath the active browser tab, and their contents are not visible in the display. However, a tabbed portion of each browser tab that is open in a web browser may be visible (in some cases, a predetermined maximum number of tabbed portions may be displayed), so that a user that views the browser window is aware of more browser tabs than just the active tab. In other implementations, browser tabs may be displayed in other ways.

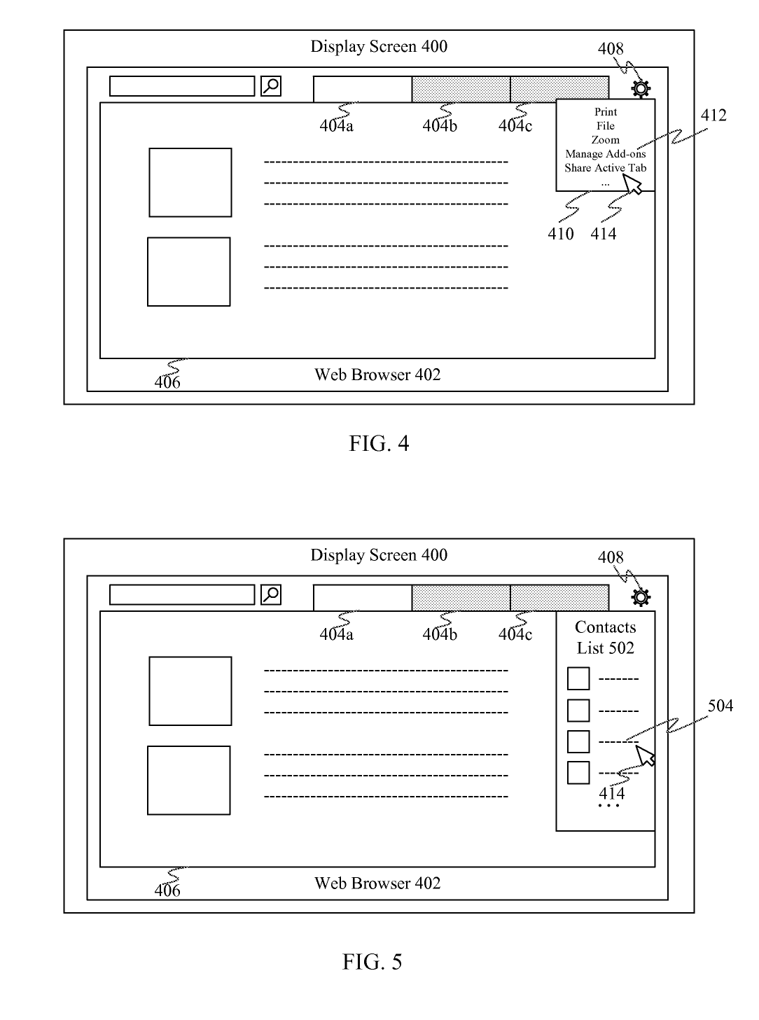

For instance, FIG. 4 shows a display screen 400 that displays a web browser 402 having multiple invoked, open browser tabs, where one of the browser tabs is active, according to an example embodiment. Web browser 402 is an example of browser 114 of FIG. 1. In FIG. 4, browser 402 includes three invoked browser tabs indicated as first browser tab 404a, second browser tab 404b, and third browser tab 404c. First browser tab 404a is the visible, outermost browser tab, and thus is the active browser tab. First browser tab 404a includes a smaller rectangular tabbed portion at top, and a larger, rectangular window portion 406. The rectangular tabbed portion extends from a top edge of window portion 406. Only the top rectangular tabbed portions of second and third browser tabs 404b and 404c are visible in FIG. 4, because their larger window portions are hidden behind window portion 406 of first browser tab 404a. Note that a web browser and a browser tab may have other configurations than shown in FIG. 4.

Referring back to flowchart 200 in FIG. 2, in step 204, a selection of a first contact with which to share the first browser tab is received at a user interface of the first computing device. In an embodiment, the user of browser 114 of FIG. 3 may select a share option provided by share selector interface 302 in a user interface 310 in association with browser tab 116 to cause a sharing of browser tab 116 with one or more other users to be initiated. For instance, the user may interact with a user interface control provided by user interface 310 (e.g., by touch, clicking on, speaking a predetermined word or phrase, making a predetermined gesture, etc.) to initiate the sharing, or may cause the sharing to be initiated in another way.

For instance, as shown in FIG. 4, a user interface control 408 may be displayed by web browser 402. User interface control 408 may be a share control that is configured specifically to enable tab sharing, or may be a more general control that includes sharing as a selectable option from multiple options (as in the example of FIG. 4). In the example of FIG. 4, user interface control 408 is shown as having a gear shape, and is shown as being located in an upper right corner of the window of web browser 402, but in other embodiments, user interface control 408 may have a different shape than shown in FIG. 4, and/or may be located elsewhere in web browser 402, including being located in first browser tab 404a or elsewhere. For instance, in one embodiment, user interface control 408 may be a selection or menu that appears (e.g., pops up) when the user interacts with the tabbed portion or window portion 406 of browser tab 404a.

In the example of FIG. 4, a user may interact with user interface control 408 in any manner, including by clicking on user interface control 408 with a pointer 414, by touch, by voice, by gesture, etc. In one embodiment, a single interaction (e.g., a click, touch, etc.) initiates a sharing process. In another embodiment, multiple interactions with user interface control 408 are used to initiate the sharing process. For instance, as shown in FIG. 4, a menu 410 may be displayed due to the interaction with user interface control 408, which includes an option of “Share Active Tab.” If the option of “Share Active Tab” is selected, a procedure for sharing the active tab of web browser 402, which is browser tab 404a in the example of FIG. 4, is initiated. As part of the process for sharing the active tab, the user of web browser 402 may be asked to select one or more contacts to share the active tab with, and/or may be asked to select a communication provider for handling the communications of sharing related data.

For instance, after selecting “Share Active Tab” in FIG. 4, the user may be enabled by share selector interface 302 to select one or more contacts. Share selector interface 302 may provide a selection mechanism that enables the user to select a contact, such as a control displayed in user interface 310. For example, FIG. 5 shows display screen 400 of FIG. 4, where a contacts list 502 is displayed for selecting a contact with which to share active browser tab 404a, according to an embodiment. In the example of FIG. 5, contacts list 502 is a list of contacts shown at the right side of web browser 402, although in other embodiments, contacts list 502 may have other configurations and/or other positions inside or outside of the window of web browser 402. Each contact listed in contacts list 520 corresponds to a particular person that the user may desire to share with. Each contact may provide various identifying information for the corresponding person, including one or more of a name, a photo, a status (e.g., online, not online), location and/or other information.

In the example of FIG. 5, the user may interact with contacts list 502 to select a contact for sharing in any manner, including by clicking on the selected contact with pointer 414, by touch, by voice, by gesture, etc. In the example of FIG. 5, the user has selected the third contact 504 in contacts list 502 using pointer 414. In some embodiments, the user may be enabled to select multiple contacts in contacts list 502 if the user desires to share the active tab with multiple contacts. As shown in FIG. 3, share selector interface 302 may receive selected contact 314 from user interface 310, which indicates one or more contacts selected by the user for sharing browser tab 116. Share selector interface 302 may output a selected contact indication 318, which may be received by other components of browser tab sharing system 340.

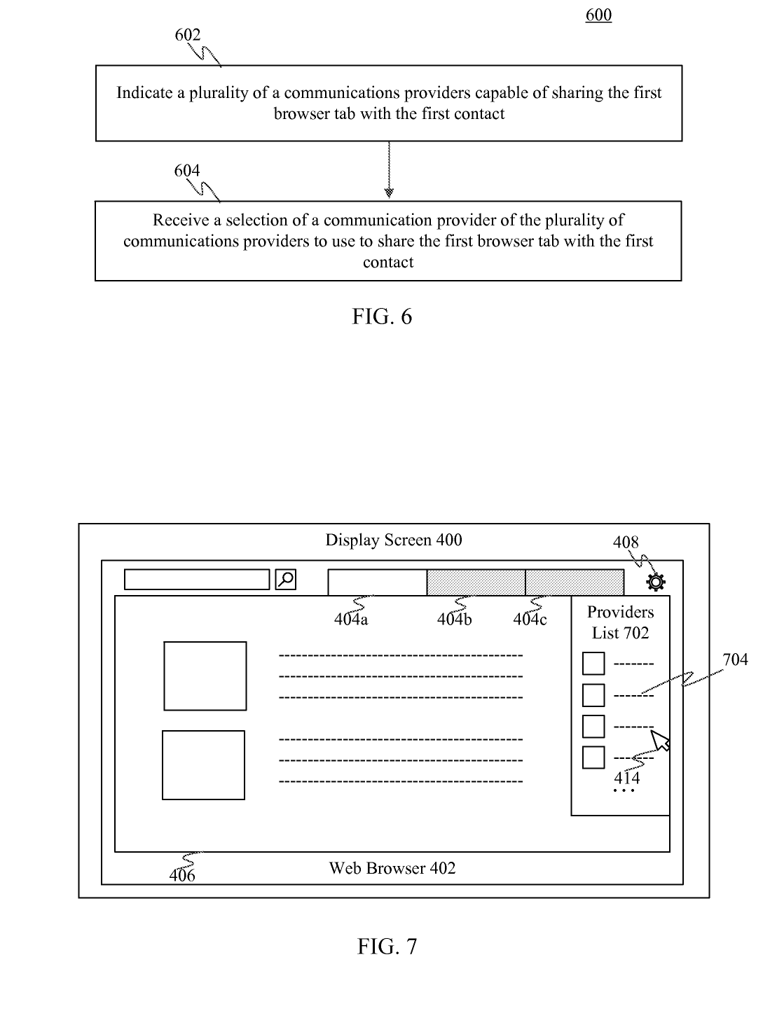

Communications with the selected contact(s) may be handled according to a preconfigured communication provider. Alternatively, communications with the selected contact(s) may be handled by a communication provider that is selected. Share selector interface 302 of FIG. 3 may provide a selection mechanism that enables the user to select a provider, such as a control displayed in user interface 310. In an embodiment where a provider is selectable, a process shown in FIG. 6 may be performed as part of flowchart 200 of FIG. 2. FIG. 6 shows a flowchart 600 providing a process for selecting a communication provider for sharing a browser tab, according to an example embodiment. Flowchart 600 is described as follows:

Flowchart 600 begins with step 602. In step 602, a plurality of a communications providers capable of sharing the first browser tab with the first contact is indicated. For instance, FIG. 7 shows display screen 400 of FIG. 4, where a providers list 702 is displayed for selecting a communication provider for sharing the active browser tab, according to an example embodiment. In the example of FIG. 7, providers list 702 is a list of communication providers shown at the right side of web browser 402, although in other embodiments, providers list 702 may have other configurations and/or other positions inside or outside of the window of web browser 402. Each communication provider listed in providers list 702 corresponds to a particular provider that the user may select to handle the sharing related communications with the selected contact(s). Providers list 702 may provide various identifying information for each listed provider, including one or more of a provider name, a logo, a status (e.g., provider is operational, provider having server/connectivity issues, etc.), and/or other information. Examples of applicable communication providers include desktop sharing applications such as Citrix® GoToMeeting®, and web conferencing applications, such as Skype®, Microsoft® Lync™, and Cisco® Webex®. Alternatively and/or additionally, a proprietary communication provider may be listed.

In step 604, a selection is received of a communication provider of the plurality of communications providers to use to share the first browser tab with the first contact. In the example of FIG. 7, the user may interact with providers list 702 to select a provider in any manner, including by clicking on the selected provider with pointer 414, by touch, by voice, by gesture, etc. In the example of FIG. 7, the user has selected the second provider in providers list 702 using pointer 414. As shown in FIG. 3, share selector interface 302 may receive selected provider 316 from user interface 310, which indicates the provider selected by the user for sharing browser tab 116.

Furthermore, as shown in FIG. 3, share selector interface 302 may output a selected provider indication 320, which indicates the selected provider. Network interface 312 receives selected provider indication 320. As such, network interface 312 configures itself to communicate shared browser information with contacts according the selected provider. Note that in another embodiment, network interface 312 may be configured to use a default communication provider.

Referring back to FIG. 2, in step 206, a share notification is transmitted to the first contact. In an embodiment, contact interface 304 is configured to transmit a share notification to the contact(s) selected in step 204 using the default or selected communication provider (e.g., selected according to flowchart 600 of FIG. 6). For example, as shown in FIG. 3, contact interface 304 receives selected contact indication 318, which indicates the contacts selected for sharing browser tab 116. Contact interface 304 is configured to generate a share notification 322 for each of the selected contacts. Network interface 312 receives share notification(s) 322, and is configured to transmit (over network 106 of FIG. 1) a share request 324 to each of the selected contacts. Network interface 312 transmits share request(s) 324 according to the communication provider being used (e.g., default or selected). Each share request 324 may be communicated according to a protocol configured according to the provider, and received by applications at computing devices of the selected contacts that are configured to handle communications according to the provider.

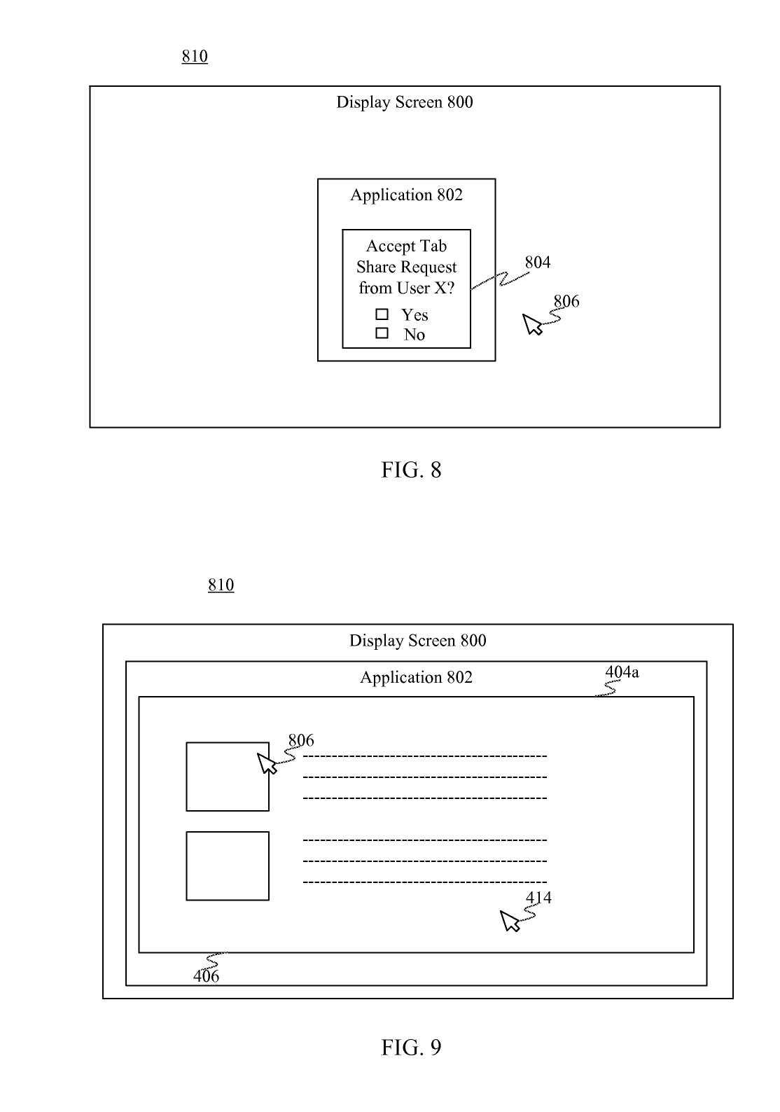

For instance, FIG. 8 shows a display screen 800 at a remote computing device 810, where a request to share a browser tab is received, according to an example embodiment. In the example of FIG. 8, computing device 810 corresponds to a contact selected at computing device 300 for sharing. A network interface of computing device 810 (not shown in FIG. 8; e.g., similar to network interface 312 in FIG. 3) received share request 324 (e.g., similarly to sharing request 128 of FIG. 1). In response, an application 802 that corresponds to the selected communication provider is invoked. In the example of FIG. 8, application 802 displays a user interface control 804 that enables a user of computing device 810, who is the selected contact, to accept or not accept share request 324. Control 804 may have any shape or form, and may be located in the display of application 802 in any position. For instance, user interface control 804 may include one or more of a push button, a check box, a menu, etc. A user may interact with user interface control 804 in any manner to indicate acceptance (or non-acceptance) of the share request, including by clicking on user interface control 804 with a pointer 806, by touch, by voice, by gesture, etc.

Note that in embodiments, application 802 may be any application configured to communicate according to the protocols or one or more communication providers mentioned herein or otherwise known, including a desktop sharing application such as Citrix® GoToMeeting®, a web conferencing application, such as Skype®, Microsoft® Lync™, or Cisco® Webex®, a proprietary communication application, or other application that enables such communications.

Referring back to FIG. 2, in step 208, an acceptance indication is received from a second computing device on behalf of the first contact. As described above, the contact at the remote computing device may accept or decline share request 324 of FIG. 3. For example, the contact at computing device 810 of FIG. 8 may interact with control 804 to accept or decline share request 324. If the contact accepts share request 324, application 802 may transmit an acceptance indication 324 from computing device 810 (e.g., in FIG. 1, share acceptance 130 transmitted over network 106) to browser tab sharing system 340 at computing device 300 shown in FIG. 3. Contact interface 304 receives acceptance indication 324 through network interface 312 from each contact that accepted the corresponding share request 322, and generates participating contacts 326, which indicates the one or more contacts with which to actually share browser tab 116.

In step 210, display of the first browser tab at the second computing device is enabled. In an embodiment, remote tab controller 306 is configured to enable display of browser tab 116 at one or more computing devices of the accepting contacts indicated in participating contacts 326, such as computing device 810 of FIG. 8. In an embodiment, remote tab controller 306 receives tab display information 328 from browser 114, which indicates the display information that defines browser tab 116 (e.g., content 118) as displayed by browser 114. For instance, tab display information 328 may include markup language code (e.g., hypertext markup language (HTML), extensible markup language (XML) code, etc.), scripts, and/or other information defining the displayed information of browser tab 116, and/or may include graphics information generated by browser 114 (e.g., by a rendering engine of browser 114) to enable display of browser tab 116 at computing device 300.

As shown in FIG. 3, remote tab controller 306 outputs tab display information 330, which includes the display information that defines browser tab 116 and indicates the accepting contacts of participating contacts 326. Network interface 312 receives tab display information 330, and is configured to transmit (over network 106 of FIG. 1) the display information that defines browser tab 116 in tab display information 330 to each of the contacts of participating contacts 326. Network interface 312 transmits the display information according to the communication provider being used (e.g., default or selected). Tab display information 330 may be communicated according to a protocol configured according to the provider, and received by applications at the computing devices of the selected contacts. With reference to FIG. 8, application 802 at computing device 810 may receive tab display information 330, and generate a display of browser tab 116 based thereon.

For example, FIG. 9 shows display screen 800 at computing device 810, where browser tab 404a is displayed by application 802, according to an example embodiment. Browser tab 404a in FIG. 9 is a copy of browser tab 404a of FIG. 4 displayed on display screen 400 of the “host” computing device (e.g., computing device 300 of FIG. 3). As such, the client at computing device 810 is displayed browser tab 404a simultaneously with the user at the host computing device, and the user therefore shares browser tab 404a with the client. One or more additional contacts may similarly be displayed a copy of browser tab 404a at their computing devices, and therefore participate in the sharing.

Referring back to FIG. 2, in step 212, the first contact is enabled to interact with the first content of the first browser tab at the second computing device. In an embodiment, the contacts at the computing devices participating in the sharing of browser tab 116 are enabled to interact with content 118 of browser tab 116. For instance, referring to FIG. 9, the contact associated with computing device 810 may interact with browser tab 404a in any manner, including by using a pointer 806, by touch, by voice, by gesture, etc.

Ongoing interactions by the user (“host”) with browser tab 404a of FIG. 4 are transmitted in display information 330 to computing device 810 to be displayed in browser tab 404a in display screen 800 by application 802. Examples of such interactions that may be displayed include interactions buttons, pulling up of menus and interacting with the same, entering of text into text entry blanks/areas, selecting hyperlinks (including hyperlinked images and/or other objects) to navigate forward and/or backward through web pages, submitting data in a form, proceeding through a series of entry forms, playing videos, playing audio files, and/or any other interactions with content of browser tab 404a. Conversely, the interactions by the contact with browser tab 404a of FIG. 8 are transmitted in remote display information 332 from application 802 of computing device 810 to the host computing device to be displayed in browser tab 404a in display screen 400 by browser 402. Remote display information 332 includes control commands, which indicate the interactions by the contact with browser tab 404a (e.g., selections, panning, zooming, etc.) so that these control commands can be implemented in browser tab 404a at the host computing device.

For instance, as shown in FIG. 3, remote interaction receiver 308 receives remote display information 332 through network interface 312. Remote display information 332 includes information (e.g., graphics data, code, etc.) that describes the interactions occurring at a remote computing device with the shared browser tab. Remote display information 332 may be received from each of the computing devices associated with each of the contacts of participating contacts 326. Remote interaction receiver 308 generates remote tab display information 334, which is received by browser 334. Remote tab display information 334 includes the information of remote display information 332 received from the one or more remote computing devices. Based on remote tab display information 334, browser 334 displays the interactions by the one or more contacts with the shared browser tab at the remote computing devices on the shared browser tab displayed locally at computing device 300.

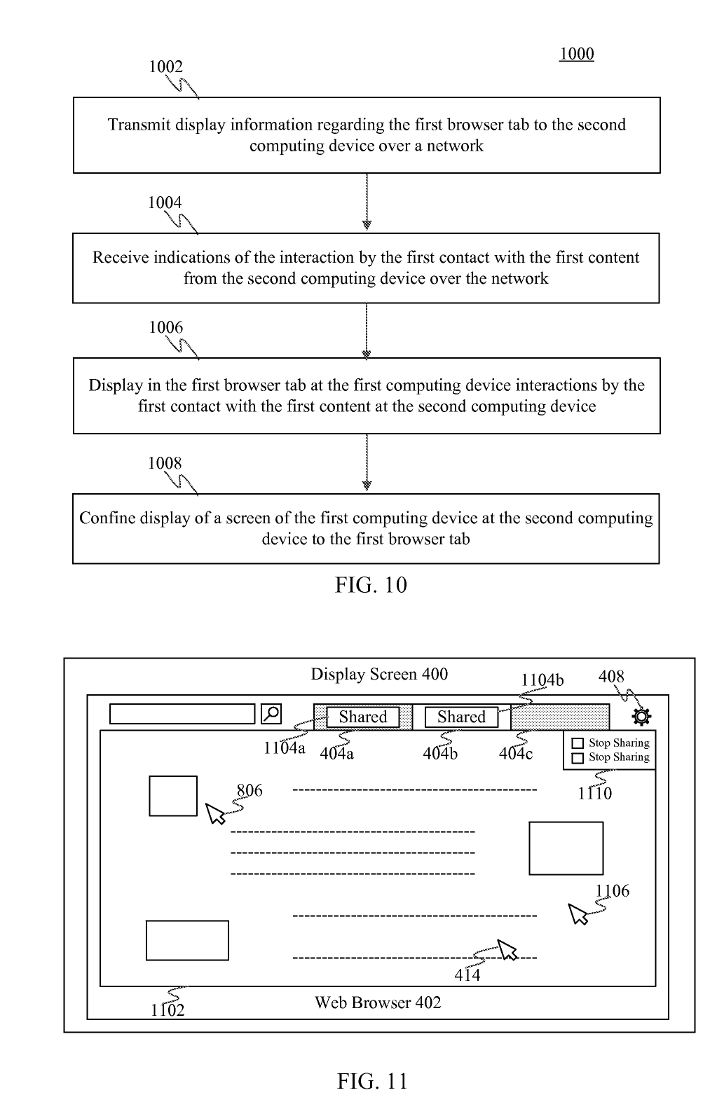

In an embodiment, remote tab controller 306 and remote interaction receiver 308 may operate according to FIG. 10. FIG. 10 shows a flowchart 1000 providing a process for enabling display of a browser tab at a remote computing device, according to an example embodiment. Further structural and operational embodiments will be apparent to persons skilled in the relevant art(s) based on the following description of flowchart 1000.

Flowchart 1000 of FIG. 10 begins with step 1002. In step 1002, display information regarding the first browser tab is transmitted to the second computing device over a network. For example, as described above with respect to step 210, remote tab controller 306 is configured to enable display of browser tab 116 at one or more computing devices of the accepting contacts indicated in participating contacts 326. In an embodiment, remote tab controller 306 receives tab display information 328 from browser 114, and outputs tab display information 330. Network interface 312 receives tab display information 330, and is configured to transmit the display information that defines browser tab 116 over network 106 (FIG. 1) to each of the contacts of participating contacts 326. For example, FIG. 9 shows display screen 800 at remote computing device 810, where browser tab 404a is displayed by application 802.

In step 1004, indications of the interaction by the first contact with the first content are received from the second computing device over the network. For example, as described above, interactions by each contact with browser tab 404a are transmitted in respective transmissions of remote display information 332 from application 802 of the corresponding computing device 810 to the host computing device. For instance, as shown in FIG. 3, remote interaction receiver 308 receives remote display information 332 through network interface 312. Remote display information 332 may be received from each of the computing devices associated with each of the contacts of participating contacts 326.

In step 1006, interactions by the first contact with the first content at the second computing device are displayed in the first browser tab at the first computing device. In an embodiment, remote interaction receiver 308 generates remote tab display information 334, which is received by browser 334. Remote tab display information 334 includes the information of remote display information 332 received from the one or more remote computing devices. Based on remote tab display information 334, browser 334 displays the interactions by the one or more contacts with the shared browser tab at the remote computing devices on the shared browser tab displayed locally at computing device 300. This is performed on an ongoing basis, so that each remote interaction by a contact with browser tab 404a is displayed locally in display screen 400. Likewise, each local interaction by the host user with browser tab 404a is displayed remotely in the respective instances of display screen 800 on an ongoing basis.

In step 1008, display of a screen of the first computing device at the second computing device is confined to the first browser tab. Note that in an embodiment, in step 1002, only display information regarding the active browser tab is transmitted to the remote computing devices. Other display information regarding the host display screen is transmitted to the remote computing devices. In this manner, the host user maintains privacy with regard to the rest of the host user's display screen. In other words, the display information transmitted to the remote computing devices is confined to, or bound by, the other edges of the browser tab.

For example, as shown in FIG. 4, in addition to browser tab 404a, display screen 400 of the host user shows the tabbed portions of browser tabs 404b and 404c, shows a URL and/or search engine entry box in an upper left region of web browser 402, shows control 408, and shows a region of display screen 400 surrounding web browser 402 (which may include other objects or tools that are open). However, as shown in FIG. 9, only browser tab 404a of display screen 400 of FIG. 4 is shown. Browser tabs 404b and 404c, control 408, and the region of display screen 400 surrounding web browser 402 are not visible in display screen 800 or application 802. Display information with respect to anything outside of browser tab 404a in display screen 400 is not provided in tab display information 330 transmitted by network interface 312 to remote computing device 810. As such, none of these objects/tools outside of the confines of browser tab 404a in display screen 400 can be displayed in display screen 800 or application 802 at remote computing device 810.

FIG. 11 shows display screen 400 of FIG. 4, where multiple browser tabs are being shared with contacts at remote computing devices, according to an example embodiment. As shown in FIG. 11, browser tabs 404a and 404b are both being shared with respective sets of one or more contacts, which may include one or more of the same contacts, or entirely different contacts. Shared indications 1104a and 1104b may be provided with respect to browser tabs 404a and 404b, respectively, to indicate that they are being shared. For instance, the word “Shared”, other text, a symbol, and/or other indication may be provide on the upper tabbed portion of the shared browser tabs, anywhere else in the shared browser tabs, and/or in the confines of web browser 402.

Note that each browser tab that is shared may be shared in a similar manner as described above with respect to FIG. 2 and elsewhere herein. Accordingly, a second browser tab showing second content may be shared with a second contact at a third computing device (e.g., third computing device 104b of FIG. 1), a third browser tab showing third content may be shared with a third contact at a fourth computing device, etc.

In the example of FIG. 11, browser tab 404b is active, and thus window portion 1102 of browser tab 404b is visible, showing content of browser tab 404b. In this example, browser tab 404b is shared with first and second contacts, as indicated by three pointers 414, 806, and 1102 being visible in FIG. 11. The host user may use pointer 414 (or other interaction forms) in browser tab 404b, and such use of pointer 414 (or other interaction forms) are made visible to the first and second contacts. Likewise, the first contact may use pointer 806 and the second contact may user pointer 1106 at their respective computing devices to interact with browser tab 404b. Such interactions by the first and second contacts are provided to the computing device of the host user. In this manner, the host user may be displayed the interactions. Furthermore, the host computing device (e.g., remote tab controller 306) is configured to provide the interactions of each of the remote contacts with browser tab 404b to the other remote computing devices so that each remote contact can be displayed the interactions by the other remote contacts with browser tab 404b.

Note that in an embodiment, the host user may disable one or more of the contacts from interacting with the content of the browser tab at their respective computing device. For example, as shown in FIG. 11, a sharing control 1110 may be displayed by web browser 402. In the example of FIG. 11, sharing control 1110 is shown as having a rectangular shape, and is shown as being located in an upper right corner of the window of web browser 402 (overlaid on browser tab 404b), but in other embodiments, sharing control 1110 may have a different shape than shown in FIG. 11, and/or may be located elsewhere in web browser 402. In the example of FIG. 11, sharing control 1110 identifies each contact that is currently sharing the active browser tab, such as by name, by an image, etc., and provides a control (e.g., a check box, a toggle switch, etc.) for each contact that may be interacted with to disable and/or enable interactions by the contact. In one embodiment, sharing control 1110 may enable the host user to disable or enable interactions by each contact with the shared browser tab. When a contact is disabled from interactions, the contact may still view the shared browser tab. In another embodiment, sharing control 1110 may enable the host user to disable or enable interactions by each contact with the shared browser tab, as well as enabling the host to remove each contact from the browser tab sharing session if desired.

III. Example Mobile and Stationary Device Embodiments

Computing device 102, computing device 104a, computing device 104b, browser tab sharing system 108, browser 114, application 110a, application 110b, computing device 300, share selector 302, contact interface 304, remote tab controller 306, remote interaction receiver 308, browser tab sharing system 340, application 802, computing device 810, flowchart 200, flowchart 600, and flowchart 1000 may be implemented in hardware, or hardware combined with software and/or firmware. For example, browser tab sharing system 108, browser 114, application 110a, application 110b, share selector 302, contact interface 304, remote tab controller 306, remote interaction receiver 308, browser tab sharing system 340, application 802, flowchart 200, flowchart 600, and/or flowchart 1000 may be implemented as computer program code/instructions configured to be executed in one or more processors and stored in a computer readable storage medium. Alternatively, browser tab sharing system 108, browser 114, application 110a, application 110b, share selector 302, contact interface 304, remote tab controller 306, remote interaction receiver 308, browser tab sharing system 340, application 802, flowchart 200, flowchart 600, and/or flowchart 1000 may be implemented as hardware logic/electrical circuitry.

For instance, in an embodiment, one or more, in any combination, of browser tab sharing system 108, browser 114, application 110a, application 110b, share selector 302, contact interface 304, remote tab controller 306, remote interaction receiver 308, browser tab sharing system 340, application 802, flowchart 200, flowchart 600, and/or flowchart 1000 may be implemented together in a SoC. The SoC may include an integrated circuit chip that includes one or more of a processor (e.g., a central processing unit (CPU), microcontroller, microprocessor, digital signal processor (DSP), etc.), memory, one or more communication interfaces, and/or further circuits, and may optionally execute received program code and/or include embedded firmware to perform functions.

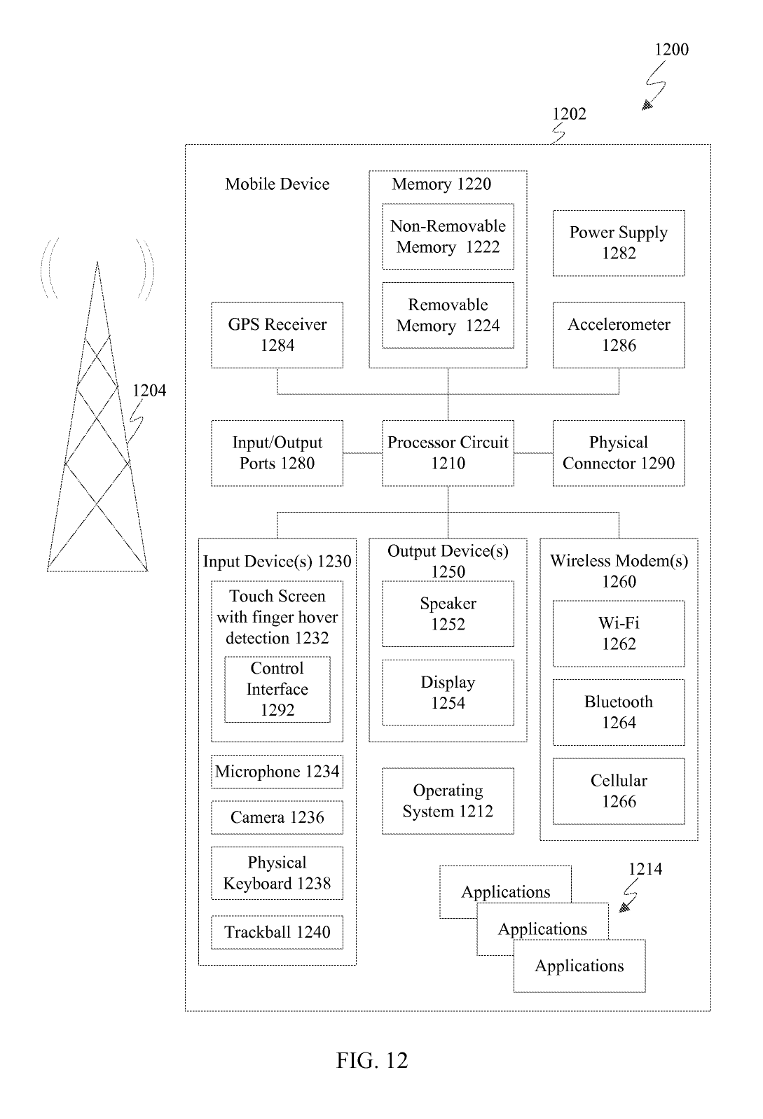

FIG. 12 shows a block diagram of an exemplary mobile device 1200 including a variety of optional hardware and software components, shown generally as components 1202. For instance, components 1202 of mobile device 1200 are examples of components that may be included in computing device 102, computing device 104a, computing device 104b (FIG. 1), computing device 300 (FIG. 3), and/or computing device 810 (FIG. 8) in mobile device embodiments. Any number and combination of the features/elements of components 1202 may be included in a mobile device embodiment, as well as additional and/or alternative features/elements, as would be known to persons skilled in the relevant art(s). It is noted that any of components 1202 can communicate with any other of components 1202, although not all connections are shown, for ease of illustration. Mobile device 1200 can be any of a variety of mobile devices described or mentioned elsewhere herein or otherwise known (e.g., cell phone, smartphone, handheld computer, Personal Digital Assistant (PDA), etc.) and can allow wireless two-way communications with one or more mobile devices over one or more communications networks 1204, such as a cellular or satellite network, or with a local area or wide area network.

The illustrated mobile device 1200 can include a controller or processor referred to as processor circuit 1210 for performing such tasks as signal coding, image processing, data processing, input/output processing, power control, and/or other functions. Processor circuit 1210 is an electrical and/or optical circuit implemented in one or more physical hardware electrical circuit device elements and/or integrated circuit devices (semiconductor material chips or dies) as a central processing unit (CPU), a microcontroller, a microprocessor, and/or other physical hardware processor circuit. Processor circuit 1210 may execute program code stored in a computer readable medium, such as program code of one or more applications 1214, operating system 1212, any program code stored in memory 1220, etc. Operating system 1212 can control the allocation and usage of the components 1202 and support for one or more application programs 1214 (a.k.a. applications, “apps”, etc.). Application programs 1214 can include common mobile computing applications (e.g., email applications, calendars, contact managers, web browsers, messaging applications) and any other computing applications (e.g., word processing applications, mapping applications, media player applications).

As illustrated, mobile device 1200 can include memory 1220. Memory 1220 can include non-removable memory 1222 and/or removable memory 1224. The non-removable memory 1222 can include RAM, ROM, flash memory, a hard disk, or other well-known memory storage technologies. The removable memory 1224 can include flash memory or a Subscriber Identity Module (SIM) card, which is well known in GSM communication systems, or other well-known memory storage technologies, such as “smart cards.” The memory 1220 can be used for storing data and/or code for running the operating system 1212 and the applications 1214. Example data can include web pages, text, images, sound files, video data, or other data sets to be sent to and/or received from one or more network servers or other devices via one or more wired or wireless networks. Memory 1220 can be used to store a subscriber identifier, such as an International Mobile Subscriber Identity (IMSI), and an equipment identifier, such as an International Mobile Equipment Identifier (IMEI). Such identifiers can be transmitted to a network server to identify users and equipment.

A number of programs may be stored in memory 1220. These programs include operating system 1212, one or more application programs 1214, and other program modules and program data. Examples of such application programs or program modules may include, for example, computer program logic (e.g., computer program code or instructions) for implementing browser tab sharing system 108, browser 114, application 110a, application 110b, share selector 302, contact interface 304, remote tab controller 306, remote interaction receiver 308, browser tab sharing system 340, application 802, flowchart 200, flowchart 600, and/or flowchart 1000 (including any suitable step of flowcharts 200, 600, 1000), and/or further embodiments described herein.

Mobile device 1200 can support one or more input devices 1230, such as a touch screen 1232, microphone 1234, camera 1236, physical keyboard 1238 and/or trackball 1240 and one or more output devices 1250, such as a speaker 1252 and a display 1254. Touch screens, such as touch screen 1232, can detect input in different ways. For example, capacitive touch screens detect touch input when an object (e.g., a fingertip) distorts or interrupts an electrical current running across the surface. As another example, touch screens can use optical sensors to detect touch input when beams from the optical sensors are interrupted. Physical contact with the surface of the screen is not necessary for input to be detected by some touch screens. For example, the touch screen 1232 may be configured to support finger hover detection using capacitive sensing, as is well understood in the art. Other detection techniques can be used, as already described above, including camera-based detection and ultrasonic-based detection. To implement a finger hover, a user's finger is typically within a predetermined spaced distance above the touch screen, such as between 0.1 to 0.25 inches, or between 0.25 inches and 0.05 inches, or between 0.5 inches and 0.75 inches or between 0.75 inches and 1 inch, or between 1 inch and 1.5 inches, etc.

The touch screen 1232 is shown to include a control interface 1292 for illustrative purposes. The control interface 1292 is configured to control content associated with a virtual element that is displayed on the touch screen 1232. In an example embodiment, the control interface 1292 is configured to control content that is provided by one or more of applications 1214. For instance, when a user of the mobile device 1200 utilizes an application, the control interface 1292 may be presented to the user on touch screen 1232 to enable the user to access controls that control such content. Presentation of the control interface 1292 may be based on (e.g., triggered by) detection of a motion within a designated distance from the touch screen 1232 or absence of such motion. Example embodiments for causing a control interface (e.g., control interface 1292) to be presented on a touch screen (e.g., touch screen 1232) based on a motion or absence thereof are described in greater detail below.

Other possible output devices (not shown) can include piezoelectric or other haptic output devices. Some devices can serve more than one input/output function. For example, touch screen 1232 and display 1254 can be combined in a single input/output device. The input devices 1230 can include a Natural User Interface (NUI). An NUI is any interface technology that enables a user to interact with a device in a “natural” manner, free from artificial constraints imposed by input devices such as mice, keyboards, remote controls, and the like. Examples of NUI methods include those relying on speech recognition, touch and stylus recognition, gesture recognition both on screen and adjacent to the screen, air gestures, head and eye tracking, voice and speech, vision, touch, gestures, and machine intelligence. Other examples of a NUI include motion gesture detection using accelerometers/gyroscopes, facial recognition, 3D displays, head, eye, and gaze tracking, immersive augmented reality and virtual reality systems, all of which provide a more natural interface, as well as technologies for sensing brain activity using electric field sensing electrodes (EEG and related methods). Thus, in one specific example, the operating system 1212 or applications 1214 can comprise speech-recognition software as part of a voice control interface that allows a user to operate the device 1200 via voice commands. Further, device 1200 can comprise input devices and software that allows for user interaction via a user's spatial gestures, such as detecting and interpreting gestures to provide input to a gaming application.

Wireless modem(s) 1260 can be coupled to antenna(s) (not shown) and can support two-way communications between processor circuit 1210 and external devices, as is well understood in the art. The modem(s) 1260 are shown generically and can include a cellular modem 1266 for communicating with the mobile communication network 1204 and/or other radio-based modems (e.g., Bluetooth 1264 and/or Wi-Fi 1262). Cellular modem 1266 may be configured to enable phone calls (and optionally transmit data) according to any suitable communication standard or technology, such as GSM, 3G, 4G, 5G, etc. At least one of the wireless modem(s) 1260 is typically configured for communication with one or more cellular networks, such as a GSM network for data and voice communications within a single cellular network, between cellular networks, or between the mobile device and a public switched telephone network (PSTN).

Mobile device 1200 can further include at least one input/output port 1280, a power supply 1282, a satellite navigation system receiver 1284, such as a Global Positioning System (GPS) receiver, an accelerometer 1286, and/or a physical connector 1290, which can be a USB port, IEEE 1394 (FireWire) port, and/or RS-232 port. The illustrated components 1202 are not required or all-inclusive, as any components can be not present and other components can be additionally present as would be recognized by one skilled in the art.

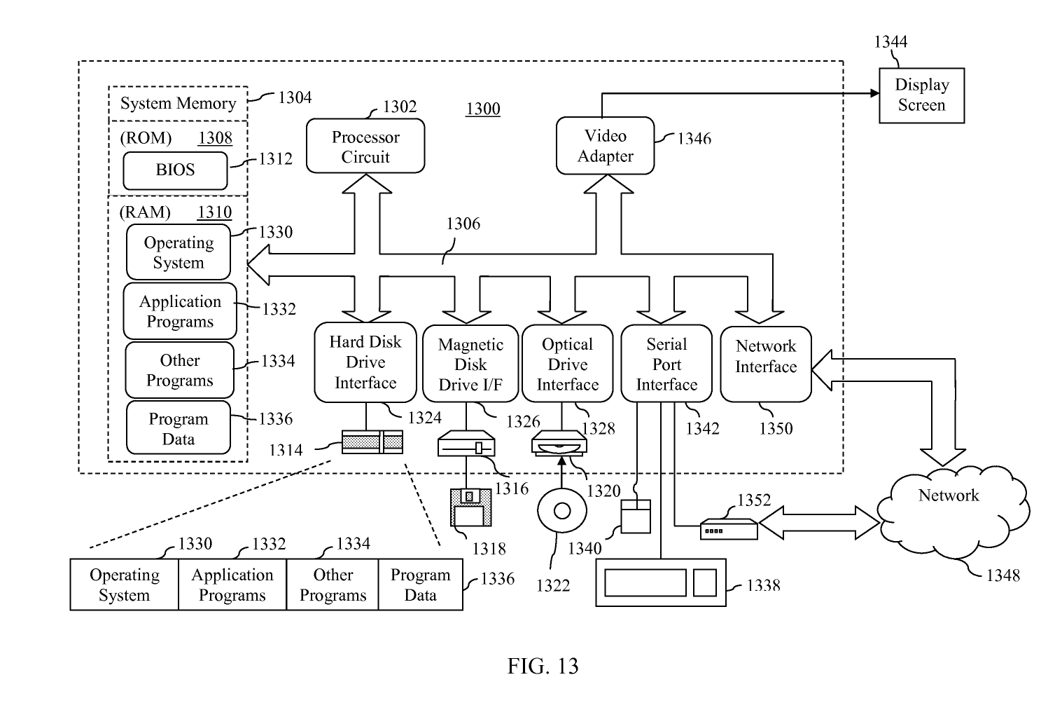

Furthermore, FIG. 13 depicts an exemplary implementation of a computing device 1300 in which embodiments may be implemented. For example, computing device 102, computing device 104a, computing device 104b, computing device 300, and/or computing device 810 may be implemented in one or more computing devices similar to computing device 1300 in stationary computer embodiments, including one or more features of computing device 1300 and/or alternative features. The description of computing device 1300 provided herein is provided for purposes of illustration, and is not intended to be limiting. Embodiments may be implemented in further types of computer systems, as would be known to persons skilled in the relevant art(s).

As shown in FIG. 13, computing device 1300 includes one or more processors, referred to as processor circuit 1302, a system memory 1304, and a bus 1306 that couples various system components including system memory 1304 to processor circuit 1302. Processor circuit 1302 is an electrical and/or optical circuit implemented in one or more physical hardware electrical circuit device elements and/or integrated circuit devices (semiconductor material chips or dies) as a central processing unit (CPU), a microcontroller, a microprocessor, and/or other physical hardware processor circuit. Processor circuit 1302 may execute program code stored in a computer readable medium, such as program code of operating system 1330, application programs 1332, other programs 1334, etc. Bus 1306 represents one or more of any of several types of bus structures, including a memory bus or memory controller, a peripheral bus, an accelerated graphics port, and a processor or local bus using any of a variety of bus architectures. System memory 1304 includes read only memory (ROM) 1308 and random access memory (RAM) 1310. A basic input/output system 1312 (BIOS) is stored in ROM 1308.

Computing device 1300 also has one or more of the following drives: a hard disk drive 1314 for reading from and writing to a hard disk, a magnetic disk drive 1316 for reading from or writing to a removable magnetic disk 1318, and an optical disk drive 1320 for reading from or writing to a removable optical disk 1322 such as a CD ROM, DVD ROM, or other optical media. Hard disk drive 1314, magnetic disk drive 1316, and optical disk drive 1320 are connected to bus 1306 by a hard disk drive interface 1324, a magnetic disk drive interface 1326, and an optical drive interface 1328, respectively. The drives and their associated computer-readable media provide nonvolatile storage of computer-readable instructions, data structures, program modules and other data for the computer. Although a hard disk, a removable magnetic disk and a removable optical disk are described, other types of hardware-based computer-readable storage media can be used to store data, such as flash memory cards, digital video disks, RAMs, ROMs, and other hardware storage media.

A number of program modules may be stored on the hard disk, magnetic disk, optical disk, ROM, or RAM. These programs include operating system 1330, one or more application programs 1332, other programs 1334, and program data 1336. Application programs 1332 or other programs 1334 may include, for example, computer program logic (e.g., computer program code or instructions) for implementing browser tab sharing system 108, browser 114, application 110a, application 110b, share selector 302, contact interface 304, remote tab controller 306, remote interaction receiver 308, browser tab sharing system 340, application 802, flowchart 200, flowchart 600, and/or flowchart 1000 (including any suitable step of flowcharts 200, 600, 1000), and/or further embodiments described herein.

A user may enter commands and information into the computing device 1300 through input devices such as keyboard 1338 and pointing device 1340. Other input devices (not shown) may include a microphone, joystick, game pad, satellite dish, scanner, a touch screen and/or touch pad, a voice recognition system to receive voice input, a gesture recognition system to receive gesture input, or the like. These and other input devices are often connected to processor circuit 1302 through a serial port interface 1342 that is coupled to bus 1306, but may be connected by other interfaces, such as a parallel port, game port, or a universal serial bus (USB).

A display screen 1344 is also connected to bus 1306 via an interface, such as a video adapter 1346. Display screen 1344 may be external to, or incorporated in computing device 1300. Display screen 1344 may display information, as well as being a user interface for receiving user commands and/or other information (e.g., by touch, finger gestures, virtual keyboard, etc.). In addition to display screen 1344, computing device 1300 may include other peripheral output devices (not shown) such as speakers and printers.

Computing device 1300 is connected to a network 1348 (e.g., the Internet) through an adaptor or network interface 1350, a modem 1352, or other means for establishing communications over the network. Modem 1352, which may be internal or external, may be connected to bus 1306 via serial port interface 1342, as shown in FIG. 13, or may be connected to bus 1306 using another interface type, including a parallel interface.

As used herein, the terms “computer program medium,” “computer-readable medium,” and “computer-readable storage medium” are used to refer to physical hardware media such as the hard disk associated with hard disk drive 1314, removable magnetic disk 1318, removable optical disk 1322, other physical hardware media such as RAMs, ROMs, flash memory cards, digital video disks, zip disks, MEMs, nanotechnology-based storage devices, and further types of physical/tangible hardware storage media (including memory 1220 of FIG. 12). Such computer-readable storage media are distinguished from and non-overlapping with communication media (do not include communication media). Communication media embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media, as well as wired media. Embodiments are also directed to such communication media that are separate and non-overlapping with embodiments directed to computer-readable storage media.

As noted above, computer programs and modules (including application programs 1332 and other programs 1334) may be stored on the hard disk, magnetic disk, optical disk, ROM, RAM, or other hardware storage medium. Such computer programs may also be received via network interface 1350, serial port interface 1342, or any other interface type. Such computer programs, when executed or loaded by an application, enable computing device 1300 to implement features of embodiments discussed herein. Accordingly, such computer programs represent controllers of the computing device 1300.

Embodiments are also directed to computer program products comprising computer code or instructions stored on any computer-readable medium. Such computer program products include hard disk drives, optical disk drives, memory device packages, portable memory sticks, memory cards, and other types of physical storage hardware.

IV. Example Embodiments

In one embodiment, a method in a first computing device comprises: invoking a first browser tab within a web browser, the first browser tab displaying first content; receiving at a user interface of the first computing device a selection of a first contact with which to share the first browser tab; transmitting a share notification to the first contact; receiving an acceptance indication from a second computing device on behalf of the first contact; enabling display of the first browser tab at the second computing device; and enabling the first contact to interact with the first content of the first browser tab at the second computing device, including displaying in the first browser tab at the first computing device interactions by the first contact with the first content at the second computing device, and confining display of a screen of the first computing device at the second computing device to the first browser tab.

In an embodiment, the receiving at a user interface of the first computing device a selection of a first contact with which to share the first browser tab comprises: receiving at the user interface selections of a plurality of contacts with which to share the first browser tab; said transmitting a share notification to the first contact comprises: transmitting share notifications to plurality of contacts; said receiving an acceptance indication from a second computing device on behalf of the first contact comprises: receiving one or more acceptance indications from one or more computing devices associated with the plurality of contacts on behalf of one or more of the plurality of contacts; and said enabling display of the first browser tab at the second computing device comprises: enabling display of the first browser tab at the one or more computing devices.

In an embodiment, the enabling the first contact to interact with the first content of the first browser tab at the second computing device comprises: enabling the one or more of the plurality of contacts at the one or more computing devices to interact with the first content of the first browser tab at the one or more computing devices.

In an embodiment, the transmitting a share notification to the first contact comprises: indicating a plurality of a communications providers capable of sharing the first browser tab with the first contact; and receiving a selection of a communication provider of the plurality of communications providers to use to share the first browser tab with the first contact.

In an embodiment, the enabling display of the first browser tab at the second computing device comprises: transmitting display information regarding the first browser tab to the second computing device over a network; and wherein said enabling the first contact to interact with the first content of the first browser tab at the second computing device comprises: receiving indications of the interaction by the first contact with the first content from the second computing device over the network.

In an embodiment, the method further comprises: disabling the first contact from interacting with the first content of the first browser tab at the second computing device.

In an embodiment, the method further comprises: invoking a second browser tab within the web browser, the second browser tab displaying second content; receiving at a user interface of the first computing device a selection of a second contact with which to share the second browser tab; transmitting a share notification to the second contact; receiving an acceptance indication from a third computing device on behalf of the second contact; enabling display of the second browser tab at the third computing device; and enabling the second contact to interact with the second content of the second browser tab at the third computing device, including: displaying in the second browser tab at the first computing device interactions by the second contact with the second content at the third computing device simultaneous with said displaying in the first browser tab at the first computing device interactions of the first contact with the first content; and confining display of the screen of the first computing device at the third computing device to the second browser tab.

In another embodiment, a system in a first computing device comprises: a share selector interface configured to receive from a user interface a selection of a first contact with which to share a first browser tab displayed by a web browser that operates in the first computing device, the first browser tab displaying first content; a contact interface configured to generate a share notification for transmit to the first contact, and to receive an acceptance indication from a second computing device on behalf of the first contact; a remote tab controller configured to enable display of the first browser tab at the second computing device, and to confine display of a screen of the first computing device at the second computing device to the first browser tab; and a remote interaction receiver configured to receive indications of interactions by the first contact with the first content of the first browser tab at the second computing device, and to enable display of the interactions in the first browser tab at the first computing device.

In an embodiment, the share selector interface is configured to receive from the user interface selections of a plurality of contacts with which to share the first browser tab; the contact interface configured to generate share notifications for transmit to the plurality of contacts, and to receive one or more acceptance indications from one or more computing devices on behalf of one or more of the plurality of contacts; and the remote tab controller configured to enable display of the first browser tab at the one or more computing devices.

In an embodiment, the remote tab controller is configured to enable the one or more of the plurality of contacts at the one or more computing devices to interact with the first content of the first browser tab at the one or more computing devices.

In an embodiment, the share selector interface is configured to indicate at the user interface a plurality of a communications providers capable of sharing the first browser tab with the first contact, and to receive a selection of a communication provider of the plurality of communications providers to use to share the first browser tab with the first contact.

In an embodiment, the remote tab controller is configured to cause display information regarding the first browser tab to be transmitted to the second computing device over a network; and the remote interaction receiver is configured to receive indications of the interaction by the first contact with the first content from the second computing device from over the network.

In an embodiment, the remote tab controller is configured to receive a request from the user interface to disable the first contact from interacting with the first content.

In an embodiment, the share selector interface is configured to receive at a user interface of the first computing device a selection of a second contact with which to share a second browser tab displayed by the web browser, the second browser tab displaying second content; the contact interface is configured to generate a share notification for transmit to the second contact, and to receive an acceptance indication from a third computing device on behalf of the second contact; the remote tab controller is configured to enable display of the second browser tab at the third computing device, and to confine display of the screen of the first computing device at the third computing device to the second browser tab; and the remote interaction receiver is configured to receive interactions of interactions by the second contact with the second content at the third computing device simultaneous with display in the first browser tab at the first computing device of interactions of the first contact with the first content.

In still another embodiment, a computer-readable storage medium comprises computer-executable instructions that, when executed by a processor, perform a method comprising: receiving at a user interface of a first computing device a selection of a first contact with which to share a first browser tab of a web browser, the first browser tab displaying first content; transmitting a share notification to the first contact; receiving an acceptance indication from a second computing device on behalf of the first contact; enabling display of the first browser tab at the second computing device; and enabling the first contact to interact with the first content of the first browser tab at the second computing device, including: displaying in the first browser tab at the first computing device interactions by the first contact with the first content at the second computing device; and confining display of a screen of the first computing device at the second computing device to the first browser tab.

In an embodiment, the receiving at a user interface of the first computing device a selection of a first contact with which to share the first browser tab comprises: receiving at the user interface selections of a plurality of contacts with which to share a first browser tab of a web browser; said transmitting a share notification to the first contact comprises: transmitting share notifications to plurality of contacts; said receiving an acceptance indication from a second computing device on behalf of the first contact comprises: receiving one or more acceptance indications from one or more computing devices associated with the plurality of contacts on behalf of one or more of the plurality of contacts; and said enabling display of the first browser tab at the second computing device comprises: enabling display of the first browser tab at the one or more computing devices.

In an embodiment, the enabling the first contact to interact with the first content of the first browser tab at the second computing device comprises: enabling the one or more of the plurality of contacts at the one or more computing devices to interact with the first content of the first browser tab at the one or more computing devices.

In an embodiment, the transmitting a share notification to the first contact comprises: indicating a plurality of a communications providers capable of sharing the first browser tab with the first contact; and receiving a selection of a communication provider of the plurality of communications providers to use to share the first browser tab with the first contact.

In an embodiment of the computer-readable storage medium, the method further comprises: disabling the first contact from interacting with the first content of the first browser tab at the second computing device.

In an embodiment of the computer-readable storage medium, the method further comprises: invoking a second browser tab within the web browser, the second browser tab displaying second content; receiving at a user interface of the first computing device a selection of a second contact with which to share the second browser tab; transmitting a share notification to the second contact; receiving an acceptance indication from a third computing device on behalf of the second contact; enabling display of the second browser tab at the third computing device; and enabling the second contact to interact with the second content of the second browser tab at the third computing device, including: displaying in the second browser tab at the first computing device interactions by the second contact with the second content at the third computing device simultaneous with said displaying in the first browser tab at the first computing device interactions of the first contact with the first content; and confining display of the screen of the first computing device at the third computing device to the second browser tab.

V. Conclusion

While various embodiments of the present invention have been described above, it should be understood that they have been presented by way of example only, and not limitation. It will be understood by those skilled in the relevant art(s) that various changes in form and details may be made therein without departing from the spirit and scope of the invention as defined in the appended claims. Accordingly, the breadth and scope of the present invention should not be limited by any of the above-described exemplary embodiments, but should be defined only in accordance with the following claims and their equivalents.

What is claimed is:

1. A method in a first computing device, comprising:
invoking a first browser tab within a web browser, the first browser tab displaying first content;
receiving at a user interface of the first computing device a selection of a first contact with which to share the first browser tab;
transmitting a share notification to the first contact;
receiving an acceptance indication from a second computing device on behalf of the first contact;
enabling display of the first browser tab at the second computing device; and
enabling the first contact to interact with the first content of the first browser tab at the second computing device, including:
displaying in the first browser tab at the first computing device interactions by the first contact with the first content at the second computing device, and
confining display of a screen of the first computing device at the second computing device to the first browser tab.

2. The method of claim 1, wherein said receiving at a user interface of the first computing device a selection of a first contact with which to share the first browser tab comprises:
receiving at the user interface selections of a plurality of contacts with which to share the first browser tab;
said transmitting a share notification to the first contact comprises:
transmitting share notifications to plurality of contacts;
said receiving an acceptance indication from a second computing device on behalf of the first contact comprises:
receiving one or more acceptance indications from one or more computing devices associated with the plurality of contacts on behalf of one or more of the plurality of contacts; and
said enabling display of the first browser tab at the second computing device comprises:
enabling display of the first browser tab at the one or more computing devices.

3. The method of claim 2, wherein said enabling the first contact to interact with the first content of the first browser tab at the second computing device comprises:
enabling the one or more of the plurality of contacts at the one or more computing devices to interact with the first content of the first browser tab at the one or more computing devices.

4. The method of claim 1, wherein said transmitting a share notification to the first contact comprises:
indicating a plurality of a communications providers capable of sharing the first browser tab with the first contact; and
receiving a selection of a communication provider of the plurality of communications providers to use to share the first browser tab with the first contact.

5. The method of claim 1, wherein said enabling display of the first browser tab at the second computing device comprises:
transmitting display information regarding the first browser tab to the second computing device over a network; and
wherein said enabling the first contact to interact with the first content of the first browser tab at the second computing device comprises:
receiving indications of the interaction by the first contact with the first content from the second computing device over the network.

6. The method of claim 1, further comprising:
disabling the first contact from interacting with the first content of the first browser tab at the second computing device.

7. The method of claim 1, further comprising:
invoking a second browser tab within the web browser, the second browser tab displaying second content;
receiving at a user interface of the first computing device a selection of a second contact with which to share the second browser tab;
transmitting a share notification to the second contact;
receiving an acceptance indication from a third computing device on behalf of the second contact;
enabling display of the second browser tab at the third computing device; and
enabling the second contact to interact with the second content of the second browser tab at the third computing device, including:
displaying in the second browser tab at the first computing device interactions by the second contact with the second content at the third computing device simultaneous with said displaying in the first browser tab at the first computing device interactions of the first contact with the first content, and
confining display of the screen of the first computing device at the third computing device to the second browser tab.

8. A system in a first computing device, comprising:
a share selector interface configured to receive from a user interface a selection of a first contact with which to share a first browser tab displayed by a web browser that operates in the first computing device, the first browser tab displaying first content;
a contact interface configured to generate a share notification for transmit to the first contact, and to receive an acceptance indication from a second computing device on behalf of the first contact;
a remote tab controller configured to enable display of the first browser tab at the second computing device, and to confine display of a screen of the first computing device at the second computing device to the first browser tab; and
a remote interaction receiver configured to receive indications of interactions by the first contact with the first content of the first browser tab at the second computing device, and to enable display of the interactions in the first browser tab at the first computing device.

9. The system of claim 8, wherein the share selector interface is configured to receive from the user interface selections of a plurality of contacts with which to share the first browser tab;
the contact interface configured to generate share notifications for transmit to the plurality of contacts, and to receive one or more acceptance indications from one or more computing devices on behalf of one or more of the plurality of contacts; and
the remote tab controller configured to enable display of the first browser tab at the one or more computing devices.

10. The system of claim 9, wherein the remote tab controller is configured to enable the one or more of the plurality of contacts at the one or more computing devices to interact with the first content of the first browser tab at the one or more computing devices.

11. The system of claim 8, wherein the share selector interface is configured to indicate at the user interface a plurality of a communications providers capable of sharing the first browser tab with the first contact, and to receive a selection of a communication provider of the plurality of communications providers to use to share the first browser tab with the first contact.

12. The system of claim 8, wherein the remote tab controller is configured to cause display information regarding the first browser tab to be transmitted to the second computing device over a network; and
the remote interaction receiver is configured to receive indications of the interaction by the first contact with the first content from the second computing device from over the network.

13. The system of claim 8, wherein the remote tab controller is configured to receive a request from the user interface to disable the first contact from interacting with the first content.

14. The system of claim 8, wherein the share selector interface is configured to receive at a user interface of the first computing device a selection of a second contact with which to share a second browser tab displayed by the web browser, the second browser tab displaying second content;
the contact interface is configured to generate a share notification for transmit to the second contact, and to receive an acceptance indication from a third computing device on behalf of the second contact;
the remote tab controller is configured to enable display of the second browser tab at the third computing device, and to confine display of the screen of the first computing device at the third computing device to the second browser tab; and
the remote interaction receiver is configured to receive interactions of interactions by the second contact with the second content at the third computing device simultaneous with display in the first browser tab at the first computing device of interactions of the first contact with the first content.

15. A computer-readable storage medium comprising computer-executable instructions that, when executed by a processor, perform a method comprising:
receiving at a user interface of a first computing device a selection of a first contact with which to share a first browser tab of a web browser, the first browser tab displaying first content;
transmitting a share notification to the first contact;
receiving an acceptance indication from a second computing device on behalf of the first contact;
enabling display of the first browser tab at the second computing device; and
enabling the first contact to interact with the first content of the first browser tab at the second computing device, including:
displaying in the first browser tab at the first computing device interactions by the first contact with the first content at the second computing device, and
confining display of a screen of the first computing device at the second computing device to the first browser tab.

16. The computer-readable storage medium of claim 15, wherein said receiving at a user interface of the first computing device a selection of a first contact with which to share the first browser tab comprises:
receiving at the user interface selections of a plurality of contacts with which to share a first browser tab of a web browser;
said transmitting a share notification to the first contact comprises:
transmitting share notifications to plurality of contacts;
said receiving an acceptance indication from a second computing device on behalf of the first contact comprises:
receiving one or more acceptance indications from one or more computing devices associated with the plurality of contacts on behalf of one or more of the plurality of contacts; and
said enabling display of the first browser tab at the second computing device comprises:
enabling display of the first browser tab at the one or more computing devices.

17. The computer-readable storage medium of claim 16, wherein said enabling the first contact to interact with the first content of the first browser tab at the second computing device comprises:
enabling the one or more of the plurality of contacts at the one or more computing devices to interact with the first content of the first browser tab at the one or more computing devices.

18. The computer-readable storage medium of claim 16, wherein said transmitting a share notification to the first contact comprises:
indicating a plurality of a communications providers capable of sharing the first browser tab with the first contact; and
receiving a selection of a communication provider of the plurality of communications providers to use to share the first browser tab with the first contact.

19. The computer-readable storage medium of claim 16, wherein the method further comprises:
disabling the first contact from interacting with the first content of the first browser tab at the second computing device.

20. The computer-readable storage medium of claim 16, wherein the method further comprises:
invoking a second browser tab within the web browser, the second browser tab displaying second content;
receiving at a user interface of the first computing device a selection of a second contact with which to share the second browser tab;
transmitting a share notification to the second contact;
receiving an acceptance indication from a third computing device on behalf of the second contact;
enabling display of the second browser tab at the third computing device; and
enabling the second contact to interact with the second content of the second browser tab at the third computing device, including:
displaying in the second browser tab at the first computing device interactions by the second contact with the second content at the third computing device simultaneous with said displaying in the first browser tab at the first computing device interactions of the first contact with the first content, and
confining display of the screen of the first computing device at the third computing device to the second browser tab.
